(19) United States
(12) Patent Application Publication
(10) Pub. No.: US 2001/0045885 A1
(43) Pub. Date: Nov. 29, 2001

(54) SYSTEM AND METHOD RETRIEVING AND DISPLAYING PAGING MESSAGES

(76) Inventor: RICHARD J. TETT, PLANO, TX (US)

Correspondence Address: DOCKET CLERK, P.O. DRAWER 800889, DALLAS, TX, 75380, US

(21) Appl. No.: 09/136,839

(22) Filed: Aug. 20, 1998

(51) Int. Cl. G08B 5/22; H04Q 7/00

(52) U.S. Cl. 340/7.2; 340/7.52; 340/7.54

(57) ABSTRACT

There is disclosed an improved message distribution system, for use in a wireless messaging system, that is capable of allowing a subscriber of the wireless messaging system to review stored wireless messages sent to the subscriber. The message distribution system comprises: 1) a first I/O interface capable of receiving a message retrieval request from the subscriber; and 2) a message retrieval controller coupled to the first I/O interface capable of determining an identity of the subscriber from identification data contained in the message retrieval request, retrieving a data record associated with the subscriber, the data record containing one or more of the stored wireless messages, and transferring to the subscriber one or more selected portions of at least one of the stored wireless messages.

### TECHNICAL FIELD OF THE INVENTION

The present invention is directed, in general, to wireless messaging systems and methods of operating the same, and, in particular, to a system and method for retrieving and displaying paging messages.

### BACKGROUND OF THE INVENTION

The demand for better and cheaper wireless telecommunication services and equipment continues to grow at a rapid pace. Part of this demand includes wireless message paging devices, which have become ubiquitous in society. Traditional one-way wireless message receiving devices (or “pagers”) are giving way to newer two-way message paging devices. Additionally, the types of messages that may be sent to a pager have expanded from short telephone number messages to include longer alphanumeric messages, faxes, graphics, e-mail, and even voice messages. In some systems, wireless messages may comprise an alphanumeric or voice message to which an electronic file, such as a text document, may be attached Despite the wider use of higher precision electronics, the implementation of time division multiple access (TDMA), frequency division multiple access (FDMA), and code division multiple access (CDMA) technologies, and the advent of narrow band PCS services, traditional problems associated with wireless messaging still persist. Message pages are frequently not delivered to a subscriber. Part of the reason for this is that the subscriber may occasionally turn off the subscriber's message paging device. But it is also true that RF signal obstructions, RF noise and multipath delay fading are significant hindrances to wireless messaging systems.

A number of technologies and/or services have attempted to overcome problems associated with the non-delivery of wireless messages. In some systems, a subscriber may call into a service by telephone and recall the last message page sent to the subscriber's paging device. The subscriber may then request that the last message be re-broadcast to the subscriber's paging device. If the subscriber is out of range, this service has no benefit.

Alternatively, the subscriber may request that the last message page be automatically converted to speech and played to the subscriber over the phone. The reliability of this service is limited, however, if an alphanumeric page is sent in a different language than is understood by the system or if unusual speech or non-traditional abbreviations are used in the message. In still other systems, undelivered message pages may be sent to the subscriber by means of an e-mail system. This type of system requires the subscriber to maintain an e-mail account and is of limited use in listening to voice messages.

Therefore, there exists a need in the art for an improved wireless communication system that allows a paging subscriber to accurately track all of the wireless messages sent to the subscriber. In particular, there exists a need in the art for an improved wireless message distribution system that maintains a database containing all of the wireless messages sent to system subscribers and allows those subscribers to access those messages at will. More particularly, there exists a need in the art for an improved wireless message distribution system that allows a subscriber to retrieve from a database and display in a convenient format on a computer screen (or listen to in a convenient audio format) selected wireless messages sent to the subscriber, including both delivered and undelivered messages.

### SUMMARY OF THE INVENTION

The limitations inherent in the prior art described above are overcome by an improved message distribution system, for use in a wireless messaging system, that is capable of allowing a subscriber of the wireless messaging system to review stored wireless messages sent to the subscriber. The message distribution system comprises: 1) a first I/O interface capable of receiving a message retrieval request from the subscriber; and 2) a message retrieval controller coupled to the first I/O interface capable of determining an identity of the subscriber from identification data contained in the message retrieval request, retrieving a data record associated with the subscriber, the data record containing one or more of the stored wireless messages, and transferring to the subscriber one or more selected portions of at least one of the stored wireless messages.

In one embodiment of the present invention, the message distribution system further comprises a database coupled to the message distribution system that is capable of storing the stored wireless messages.

In another embodiment of the present invention, the message distribution system requires the subscriber to enter a password prior to transferring to the subscriber the one or more selected portions of the at least one of the stored wireless messages.

In still another embodiment of the present invention, the first I/O interface is capable of receiving a wireless message directed to the subscriber.

In yet another embodiment of the present invention, the message distribution system further comprises a second I/O interface capable of sending the received wireless message to an RF transceiver facility operable to transmit the received wireless message to a paging device of the subscriber.

According to a further embodiment of the present invention, the message distribution system further comprises an incoming wireless message controller capable of determining an identity of the subscriber from identification data contained in the received wireless message.

According to a still further embodiment of the present invention, the message distribution system is capable of receiving from the RF transceiver facility a response message responsive to a transmission of the received wireless message to the paging device.

According to a yet further embodiment of the present invention, the message retrieval request is received from a public telephone system. In an alternate embodiment of the present invention, the message retrieval request is received from a wide area data network.

The foregoing SUMMARY OF THE INVENTION outlines, rather broadly, some advantageous features of various embodiments of the present invention so that those of ordinary skill in the art may better understand the DETAILED DESCRIPTION that follows. Additional features of the invention will be described hereafter that form the subject matter of the CLAIMS OF THE INVENTION. Those of ordinary skill in the art should appreciate that they can readily use the disclosed invention and specific embodiments as a basis for designing or modifying other structures for carrying out the same purposes of the present invention. Those of ordinary skill in the art should also realize that such equivalent constructions do not depart from the spirit and scope of the present invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or, ” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, be a property of, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, reference is now made to the following descriptions taken in conjunction with the accompanying drawings, wherein like numbers designate like objects and in which:

FIG. 1 illustrates a representative portion of a message paging network in accordance with one embodiment of the present invention;

FIG. 2 illustrates representative subscriber data records in a message database in the message paging network in accordance with one embodiment of the present invention;

FIG. 3 illustrates an exemplary wireless messaging distribution system according to one embodiment of the present invention;

FIG. 4 is a flow diagram illustrating a wireless message receipt and forwarding operation of a representative wireless messaging distribution system in accordance with one embodiment of the present invention; and

FIG. 5 is a flow diagram illustrating a wireless message retrieval operation of a representative wireless messaging distribution system in accordance with one embodiment of the present invention.

### DETAILED DESCRIPTION

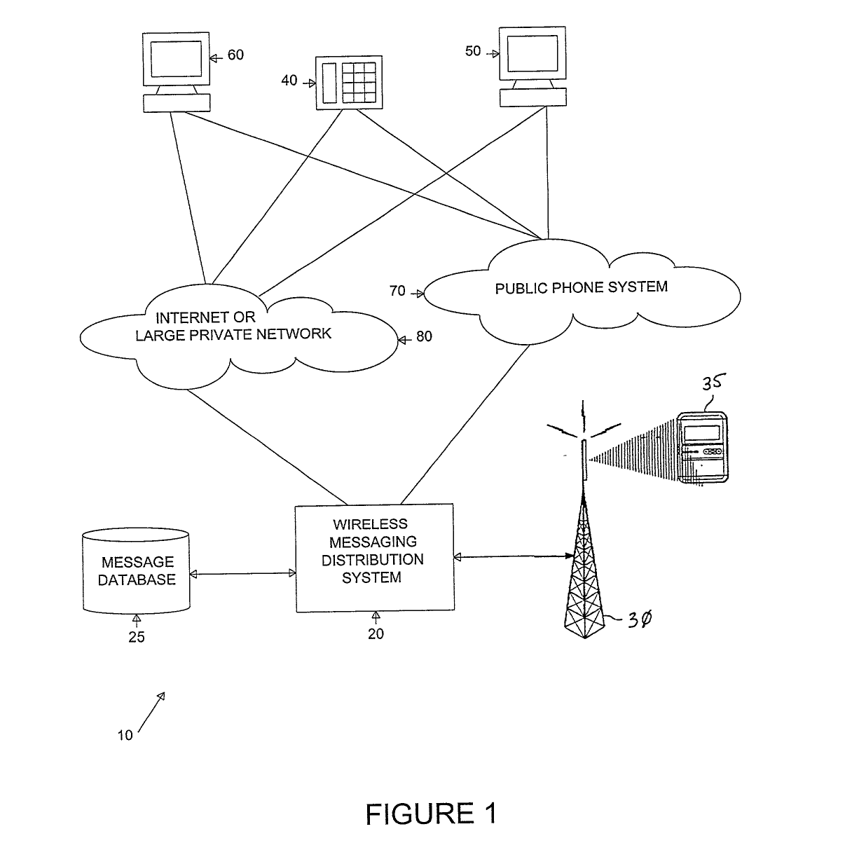

Turning initially to FIG. 1, there is illustrated a representative portion of a message paging network 10 in accordance with one embodiment of the present invention. Message paging network 10 comprises a wireless messaging distribution system 20, a message database 25, and an RF transmitter and receiver facility 30 (hereafter, “RF transceiver 30”) for sending wireless messages to a subscriber's paging device 35 and, optionally, receiving wireless response messages therefrom. Depending on the level of service for which the subscriber has paid, RF transceiver 30 may send data and/or voice messages in one direction only (i.e., to the paging device 35). Alternatively, data and/or voice signals may be communicated bidirectionally between RF transceiver 30 and paging device 35. The RF transceiver 30 may comprise a single transmitter and receiver facility or may comprise an entire infrastructure of many transmitters and receivers covering a large geographical area.

Wireless messaging distribution system 20 receives wireless messages from a variety of input sources, including a standard telephone 40 and a message generating computer 50, and transmits the wireless messages to paging device 35 via RF transceiver 30. Information related to each wireless message is stored in message database 25 for later retrieval and viewing by the subscriber.

Wireless messages may be entered by a caller on telephone 40 by pressing the telephone keypad buttons to thereby generate DTMF tones that are interpreted by wireless messaging distribution system 20 as, for example, a telephone number that the subscriber should call in order to respond. In more sophisticated systems, combinations of DTMF tones may be interpreted as letters and numbers (i.e., alphanumeric characters) to thereby enable the caller to send alphanumeric text messages to the subscriber. In a wireless messaging system, the caller may enter voice messages that are sent to paging device 35.

Message generating computer 50 is representative of any one of a large number of processing devices that may be used to create alphanumeric text and/or voice messages that are sent to paging device 35 and, optionally, to receive response messages from paging device 35. For example, message generating computer 50 may be a standard desktop personal computer (PC), a laptop PC, a hand held processing device, such as a PalmPilot®, a two-way paging device, or the like. Message generating computer 50 may also include a dedicated paging controller embedded in a larger piece of equipment, such as an oil rig, a vending machine, or a vehicle, that generates paging messages, particularly alarms and notifications, in order to alert a supervisor or maintenance person of a condition in the equipment.

Wireless messaging distribution system 20 also communicates with a message retrieval computer 60. Message retrieval computer 60 is also representative of any one of a large number of processing devices that may be used to retrieve and display information stored in message database 25 relating to alphanumeric text and/or voice messages that were sent to paging device 35 and, optionally, to retrieve and display information relating to response messages that were sent by paging device 35. For example, message retrieval computer 60 may be a standard desktop personal computer (PC), a laptop PC, or a hand held processing device, such as a PalmPilot®, or the like. In one embodiment of the present invention, message retrieval computer 60 comprises a desktop PC capable of operating a browser application, such as Netscape Navigator® or MicroSoft Internet Explorer®.

Wireless messaging distribution system 20 may communicate with message retrieval computer 60, telephone 40, and message generating computer 50 via the public phone system 70 or by the Internet (or a large private network) 80. At least portions of the phone system 70 or Internet (large private network) 80 may include a wireless network. Although wireless messages may be transferred to the wireless messaging distribution system 20 by telephone 40 and message generating computer 50 through either the public phone system 70 or the Internet 80, as a practical matter, most “conventional” numeric paging messages are be received via the public phone system 70. The means by which a subscriber using message retrieval computer 60 accesses wireless messaging distribution system 20 may be selected at the subscriber's option. The subscriber may use a direct dial-in connection to wireless messaging distribution system 20 (i.e., via the public phone system 70) or may use a browser application on message retrieval computer 60 to access wireless messaging distribution system 20 via the Internet 80, or both.

In a preferred embodiment of the present invention, wireless messaging distribution system 20 is essentially a server that receives wireless messages from different clients via the public telephone system 70 and the Internet 80, forwards the messages to RF transceiver 30, and stores copies of the wireless messages in database 25. Wireless messaging distribution system 20 then allows client devices to use graphical user interfaces to selectively view and retrieve the copies of the wireless messages. After a wireless message has been retrieved, the subscriber can then issue a response message or generate a new follow-up message(s). Once a subscriber has entered into a session with the server in wireless messaging distribution system 20 by entering a subscriber ID and a password, the subscriber can issue response messages and/or generate new follow-up messages without re-entering the subscriber ID or re-entering the address of the party to whom the subscriber wishes to send a response message.

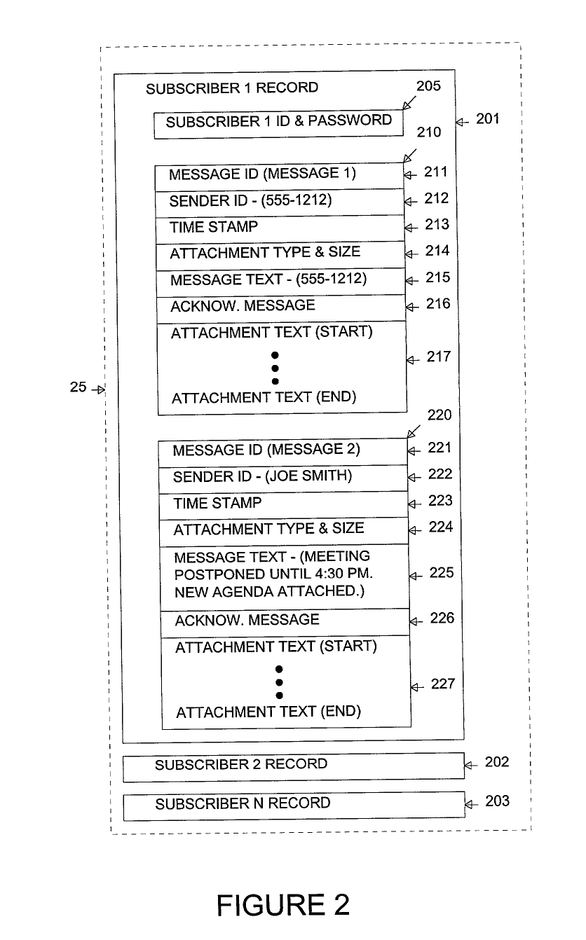

FIG. 2 illustrates representative subscriber data records 201-203 in message database 25 in message paging network 10 in accordance with one embodiment of the present invention. The contents of subscriber data records 201-203 vary according to the type of messaging service for which the subscriber has paid. Nonetheless, subscriber data record 201 (hereafter “Subscriber 1 Record”) is representative of any one of the records for Subscriber 1 through Subscriber N. In Subscriber 1 Record, received message 210 and received message 220 have been stored in message database 25 by wireless messaging distribution system 20.

Subscriber 1 Record contains a Subscriber 1 ID and Password field that is used to access the correct subscriber data record and confirm the identity of Subscriber 1. In an exemplary embodiment, the ID of Subscriber 1 is simply the telephone number of the paging device 35 used by Subscriber 1. When a wireless message is sent from telephone 40 or message generating computer 50 to paging device 35, a copy of the message is stored in message database 25 in a subscriber data record identified by the subscriber telephone number associated with paging device 35. During message retrieval, the subscriber enters the telephone number associated with paging device 35 to initiate access to the Subscriber 1 Record and wireless messaging distribution system 20 then requests a password from the subscriber before granting actual access. If the subscriber enters the proper password, the subscriber can retrieve and view wireless messages 210 and 220, as well as any others left for Subscriber 1.

Wireless message 210 comprises a Message ID field 211 containing the identifier “Message 1”. In a preferred embodiment of the present invention, the Message ID may also include a sub-field used to indicate the message status, such as “delivered”, “undelivered”, “read”, “unread”, and the like. Wireless message 210 also comprises a Sender ID (or return address) field 212. In the example shown, wireless message distribution system 220 has used Caller ID data received from the public phone system 70 to insert in the Sender ID field 212 the telephone number (i.e., 555-1212) of the caller/message sender. In an alternate scenario, wireless message distribution system 220 may insert in the Sender ID field 212 an e-mail address of the message sender for alphanumeric messages received from the Internet 80. In still another alternate scenario, wireless message distribution system 220 may insert in the Sender ID field 212 a pager address as the return address of the message sender. A Time Stamp field 213 in wireless message 210 contains the time at which the caller left wireless message record 210.

Wireless message 210 further comprises an Attachment Type & Size field 214. In a preferred embodiment of the present invention, a caller/message sender using message generating computer 50 may attach a document, such as a WordPerfect document or an MS Word document to a wireless message sent to paging device 35. A value of zero, for example, may be inserted in the Attachment Type & Size field 214 to indicate that there is no attachment. A non-zero value in the Attachment Type & Size field 214 may be used to indicate to the subscriber that there is an attachment associated with wireless message record 210 and further, what type of file the attachment is (i.e., text document, voice message file, or the like). Advantageously, this allows the subscriber to determine what the attachment is before requesting that the attachment be downloaded to, for example, the message retrieval computer 60.

A Message Text field 215 in wireless message 210 stores the contents of the actual wireless message sent to the paging device 35. In the example shown, the caller has entered his own telephone number (i.e., 555-1212) on, for example, the button keypad of telephone 40. An Acknowledgment Message field 216 holds a response message, if any, received from paging device 35 acknowledging receipt of wireless message 210 by paging device 35. Finally, Attachment Text field 217 holds the contents of any attached document identified in the Attachment Type field 214.

Likewise, wireless message 220 stored in message database 225 comprises a Message ID field 221, a Sender ID field 222, a Time Stamp 223, an Attachment Type field 224, a Message Text field 225, an Acknowledgment Message field 226, and an Attachment Text field 227. Whereas wireless message record 210 consists of a simple telephone number message page entered by a caller using the telephone keypad buttons of telephone 40, wireless message record 220 is a more complex message that consists of an alphanumeric message and an attachment sent by a caller using message generating computer 50.

The Message ID field 212 in wireless message 220 contains the identifier “Message 2”. In the example shown, wireless message distribution system 220 has inserted the name (“Joe Smith”) of the message sender in the Sender ID field 222. Wireless message distribution system 220 may obtain the message sender's name using Caller ID data received from the public phone system 70. Alternatively, the message sender may directly enter his or her own name, or the message sender's name may be extracted from the header data of an e-mail. One again, a Time Stamp field 223 in wireless message 210 contains the time at which the caller left wireless message record 220.

The Attachment Type field 224 in wireless message 220 indicates that an attachment is associated with wireless message 220 and indicates that it is a text document. The Message Text field 225 in wireless message 220 stores the contents of the actual wireless message sent to the paging device 35. In the case the wireless message states, “Meeting postponed until 4:30 PM. New agenda attached.” As before, the Acknowledgment Message field 226 holds a response message, if any, received from paging device 35 acknowledging receipt of wireless message 220 by paging device 35. Finally, Attachment Text field 227 holds the contents of the attached document identified in the Attachment Type field 224, which in this case is an agenda document.

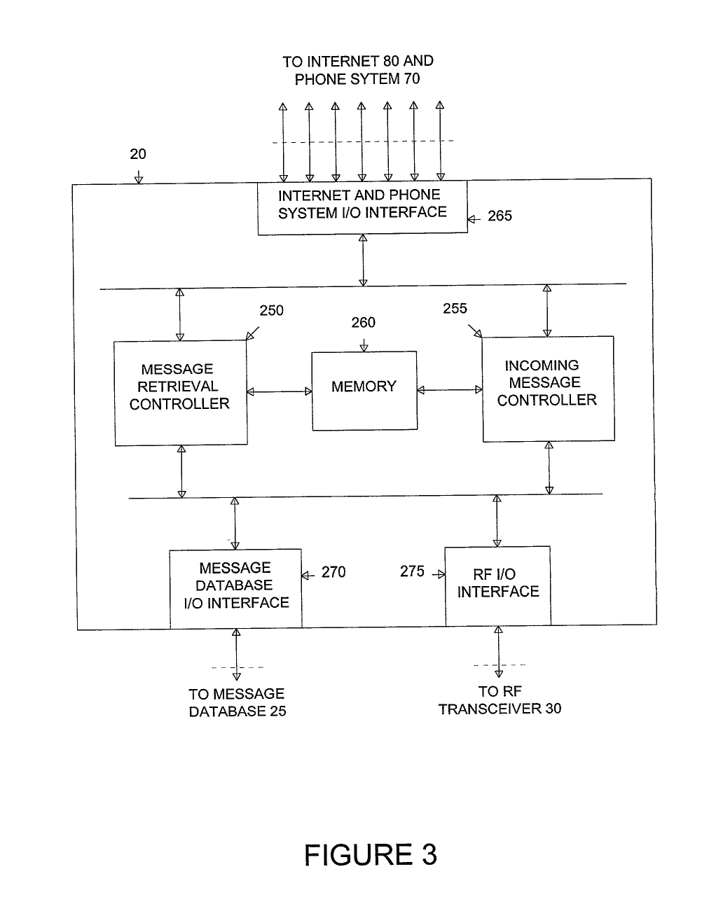

FIG. 3 illustrates an exemplary wireless messaging distribution system 20 according to one embodiment of the present invention. Wireless messaging distribution system 20 in the exemplary embodiment is a server that handles incoming wireless messages intended for paging device 35, and also handles message retrieval requests received from subscribers attempting to review stored wireless messages. Wireless messaging distribution system 20 comprises a message retrieval controller 250, an incoming message controller 255, and an associated memory 260 shared by both controllers.

Message retrieval controller 250 and incoming message controller 255 are coupled by a common bus to Internet and phone system I/O interface 265, which bi-directionally transfers data to and from public phone system 70 and Internet 80. Incoming wireless messages are directed by Internet and phone system I/O interface 265 to incoming message controller 255. Message retrieval requests are similarly directed to message retrieval controller 250 by Internet and phone system I/O interface 265. Internet and phone system I/O interface 265 may distinguish between incoming wireless messages and incoming message retrieval requests according to the received Internet address or the telephone number to which the incoming call is directed.

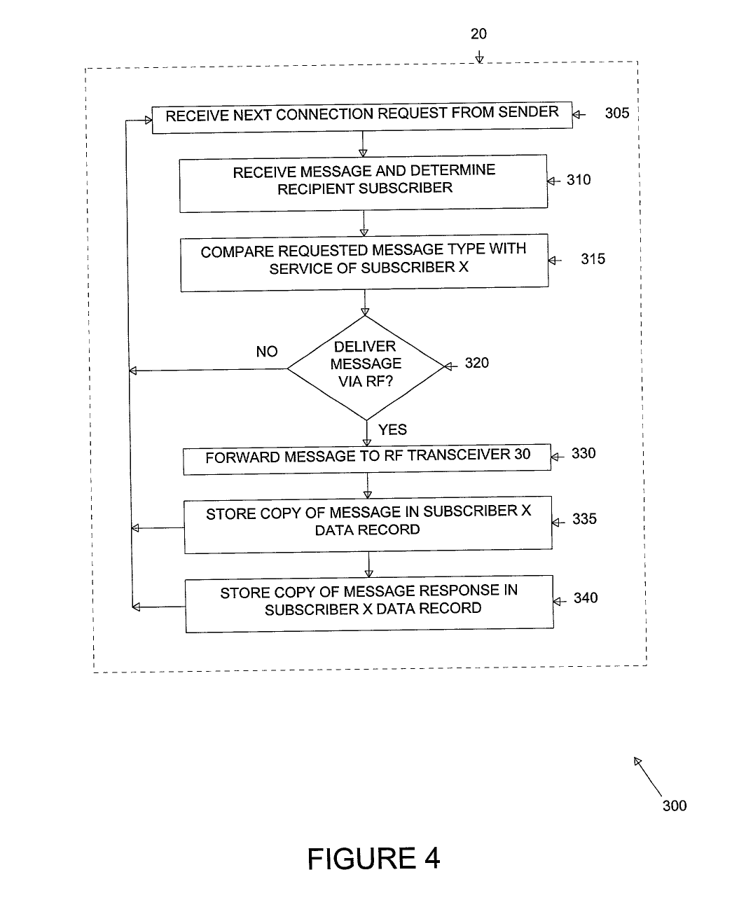

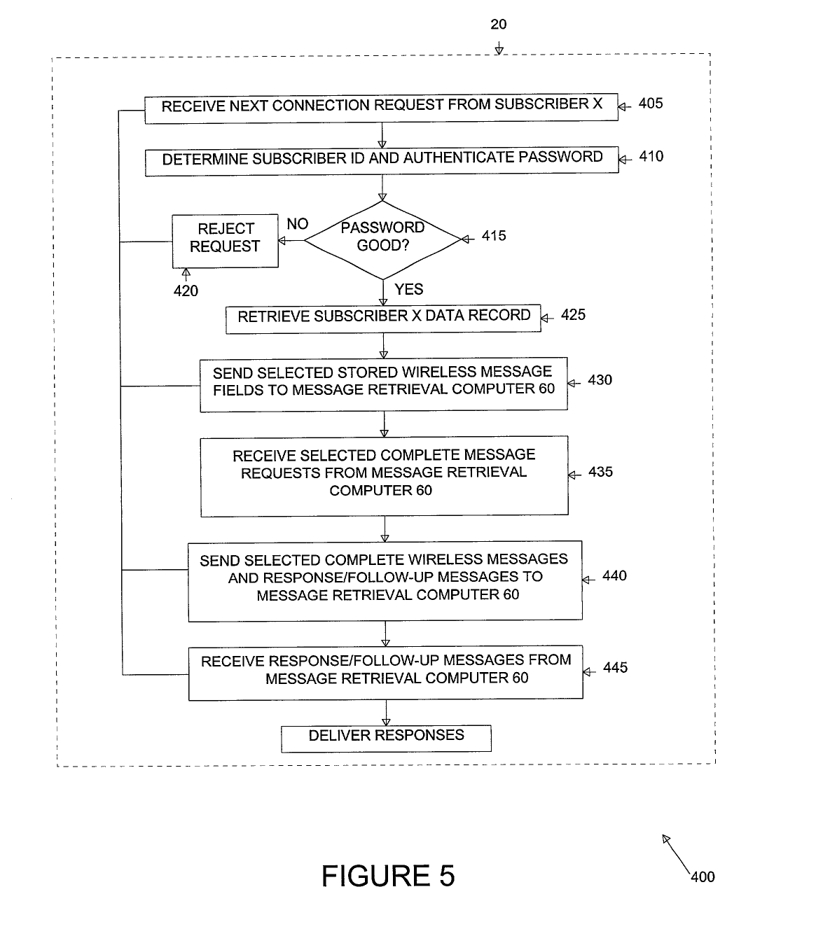

Message retrieval controller 250 and incoming message controller 255 are also connected by means of a common bus to message database I/O interface 270 and RF I/O interface 275. Message database I/O interface 270 stores and retrieves subscriber data records to and from message database 25. RF I/O interface 275 transfers incoming wireless messages to RF transceiver 30 and, in the case or two-way messaging systems, receives wireless messages from RF transceiver 30. The methods by which incoming message controller 255 handles incoming wireless messages are described below in greater detail in connection with FIG. 4. The methods by which message retrieval controller 250 handles incoming message retrieval requests are described below in greater detail in connection with FIG. 5.

FIG. 4 is a flow diagram 300 illustrating a wireless message receipt and forwarding operation of a representative wireless messaging distribution system in accordance with one embodiment of the present invention. Initially, wireless messaging distribution system 20 receives an incoming connection request from a wireless message sender from either public phone system 70 or Internet 80 (method step 305). Next, wireless messaging distribution system 20 receives the contents of the wireless message itself and determines therefrom the recipient subscriber to whom the wireless message must be transmitted via RF transceiver 30 (method step 310).

Wireless messaging distribution system 20 compares the incoming wireless message type with the service for which the recipient subscriber (hereafter “Subscriber X”) has subscribed (method step 315). This step insures that the sender does not attempt to send an incompatible message type to paging device 35, such as, for example, sending a voice message to an alphanumeric paging device. If the incoming message type is incompatible with the service of Subscriber X, or cannot be converted to a compatible type by the system, wireless messaging distribution system 20 rejects the wireless message and returns to the initial state of waiting for the next connection request from a sender (method steps 320 and 305). If the message type is compatible with the service of Subscriber X, or can be converted by the system, wireless messaging distribution system 20 forwards the wireless message to RF transceiver 30 for transmission to paging device 35 (method steps 320 and 330).

Wireless messaging distribution system 20 then stores a copy of the wireless message in the data record of Subscriber X in message database 25 (method step 335). Finally, if paging device 35 used by Subscriber X is capable of generating response messages (as in a two-way messaging system), wireless messaging distribution system 20 stores a copy of the wireless response message received from paging device 35 in the data record of Subscriber X in message database 25 (method step 340).

FIG. 5 is a flow diagram 400 illustrating a wireless message retrieval operation of a representative wireless messaging distribution system in accordance with one embodiment of the present invention. Initially, wireless messaging distribution system 20 receives a connection request from Subscriber X, who is attempting to retrieve and display stored wireless messages (method step 405). Before allowing this transaction, wireless messaging distribution system 20 authenticates the identity of Subscriber X by requesting that Subscriber X enter a Subscriber ID and a corresponding password (method step 410). If the password entered by Subscriber X does not match the stored password, wireless messaging distribution system 20 rejects the connection request from Subscriber X (method steps 415 and 420). If the password entered by Subscriber X matches the stored password for Subscriber X data record in message database 25, wireless messaging distribution system 20 retrieves the data record of Subscriber X from message database 25 (method steps 415 and 425).

Next, wireless messaging distribution system 20 sends selected fields of the stored wireless messages to message retrieval computer 60 used by Subscriber X (method step 430). By sending only selected portions of the stored wireless messages, rather than the entirety of the stored wireless messages, wireless messaging distribution system 20 allows Subscriber X to review the truncated/abbreviated information before requesting that all of one or more wireless messages be downloaded to message retrieval computer 60. This advantageously conserves bandwidth between wireless messaging distribution system 20 and message retrieval computer 60 and prevents the undesirable downloading of unexpectedly large attached documents to Subscriber X without first warning of the size of the attached document.

After Subscriber X has reviewed the selected wireless message information displayed on message retrieval computer 60, wireless messaging distribution system 20 may receive selected requests from Subscriber X to download complete wireless messages from message database 25 to message retrieval computer 60 (method step 435). Upon receiving such a complete message retrieval request, wireless messaging distribution system 20 sends corresponding complete wireless messages and response/follow-up messages, if any, to message retrieval computer 60 (method step 440).

Finally, wireless messaging distribution system 20 may receive from Subscriber X one or more response/follow-up messages corresponding to one or more of the complete wireless messages and response/follow-up messages that were downloaded to message retrieval computer 60 (method step 445). Wireless messaging distribution system 20 may then forward the response/follow-up message(s) to the sender(s) of the original wireless message(s) sent to Subscriber X (method step 450).

In a preferred embodiment of the present invention, accessing a message through message retrieval computer 60 before the message has been delivered by RF transmission to a pager may cause the cancellation of the RF transmission if the subscriber chooses that option. For example, if a subscriber has traveled outside of the subscriber's coverage area (or has turned the pager “OFF”), the subscriber may nonetheless use message retrieval computer 60 to retrieve a message that has not been delivered to the pager. When the subscriber returns to the subscriber's coverage area (or turns the pager “ON” again), RF transceiver 30 will transmit what is now a redundant message to the subscriber. To prevent this from happening, the subscriber may select a system option that cancels the subsequent RF transmission of any currently undelivered message if the undelivered message is first retrieved by message retrieval computer 60.

Although the principles of the present invention have been described in detail with reference to message paging system and infrastructure embodiments, those of ordinary skill in the art should understand that they can make various changes, substitutions and alterations herein without departing from the spirit and scope of the invention in its broadest form.

What is claimed is:

1. For use in a wireless messaging system, a message distribution system capable of allowing a subscriber of said wireless messaging system to review stored wireless messages sent to said subscriber comprising:
a first I/O interface capable of receiving a message retrieval request from said subscriber;
a message retrieval controller coupled to said first I/O interface capable of determining an identity of said subscriber from identification data contained in said message retrieval request, retrieving a data record associated with said subscriber, said data record containing one or more of said stored wireless messages, and transferring to said subscriber one or more selected portions of at least one of said stored wireless messages.

2. The message distribution system set forth in claim 1 further comprising a database coupled to said message distribution system capable of storing said stored wireless messages.

3. The message distribution system set forth in claim 1 wherein said message distribution system requires said subscriber to enter a password prior to transferring to said subscriber said one or more selected portions of said at least one of said stored wireless messages.

4. The message distribution system set forth in claim 1 wherein said first I/O interface is capable of receiving a wireless message directed to said subscriber.

5. The message distribution system set forth in claim 4 further comprising a second I/O interface capable of sending said received wireless message to an RF transceiver facility operable to transmit said received wireless message to a paging device of said subscriber.

6. The message distribution system set forth in claim 4 further comprising an incoming wireless message controller capable of determining an identity of said subscriber from identification data contained in said received wireless message.

7. The message distribution system set forth in claim 5 wherein said message distribution system is capable of receiving from said RF transceiver facility a response message responsive to a transmission of said received wireless message to said paging device.

8. The message distribution system set forth in claim 1 wherein said message retrieval request is received from a public telephone system.

9. The message distribution system set forth in claim 1 wherein said message retrieval request is received from a wide area data network.

10. A wireless messaging system comprising:
a plurality of RF transceiver facilities capable of transmitting and receiving wireless messages to and from paging devices used by subscribers of said wireless messaging system;
a message distribution system capable of allowing a subscriber of said wireless messaging system to review stored wireless messages sent to said subscriber comprising:
a first I/O interface capable of receiving a message retrieval request from said subscriber; and
a message retrieval controller coupled to said first I/O interface capable of determining an identity of said subscriber from identification data contained in said message retrieval request, retrieving a data record associated with said subscriber, said data record containing one or more of said stored wireless messages, and transferring to said subscriber one or more selected portions of at least one of said stored wireless messages; and
a database coupled to said message distribution system capable of storing said stored wireless messages.

11. The wireless messaging system set forth in claim 10 wherein said message distribution system requires said subscriber to enter a password prior to transferring to said subscriber said one or more selected portions of said at least one of said stored wireless messages.

12. The wireless messaging system set forth in claim 10 wherein said first I/O interface is capable of receiving a wireless message directed to said subscriber.

13. The wireless messaging system set forth in claim 12 further comprising a second I/O interface capable of sending said received wireless message to an RF transceiver facility operable to transmit said received wireless message to a paging device of said subscriber.

14. The wireless messaging system set forth in claim 12 further comprising an incoming wireless message controller capable of determining an identity of said subscriber from identification data contained in said received wireless message.

15. The wireless messaging system set forth in claim 13 wherein said message distribution system is capable of receiving from said RF transceiver facility a response message responsive to a transmission of said received wireless message to said paging device.

16. The wireless messaging system set forth in claim 10 wherein said message retrieval request is received from a public telephone system.

17. The message distribution system set forth in claim 10 wherein said message retrieval request is received from a wide area data network.

18. For use in a wireless messaging system, a method for allowing a subscriber of the wireless messaging system to view on a display device stored wireless messages sent to the subscriber comprising the steps of:
receiving a message retrieval request from the subscriber;
determining an identity of the subscriber from identification data contained in the message retrieval request;
retrieving a data record associated with the subscriber, the data record containing one or more of the stored wireless messages sent to the subscriber; and
transferring to the subscriber one or more selected portions of at least one of the stored wireless messages.

19. The method set forth in claim 18 including the further step of requiring the subscriber to enter a password prior to transferring to the subscriber the one or more selected portions of the at least one stored wireless messages.

20. The method set forth in claim 18 including the further steps of:
receiving from the subscriber a complete message retrieval request; and
in response thereto, transferring to the subscriber all of a selected one of the at least one stored wireless messages.
